(19) United States
(12) Patent Application Publication
(10) Pub. No.: US 2024/0269508 A1
(43) Pub. Date: Aug. 15, 2024

(54) Partner Treadmill Device

(71) Applicant: Lana Schlosser, Billings, MT (US)

(72) Inventor: Lana Schlosser, Billings, MT (US)

(21) Appl. No.: 18/398,244

(22) Filed: Dec. 28, 2023

Related U.S. Application Data
(60) Provisional application No. 63/445,492, filed on Feb. 14, 2023.

(51) Int. Cl. A63B 22/02; A01K 15/02; A63B 21/00; A63B 24/00

(52) U.S. Cl. CPC A63B 22/02; A01K 15/027; A63B 21/4035; A63B 24/0087; A63B 2071/0694; A63B 2225/107

(57) ABSTRACT

A partner treadmill device with two separate running surfaces or treads is disclosed. The partner treadmill device comprises a body component that is configured in the shape of a conventional treadmill, having a base component, two arm components, and a control component. The base component comprises two tread components, constructed side-by-side. Thus, the partner treadmill component can be used by one or two users simultaneously. Further, the control component allows users to operate the tread components and speed of the device. Thus, users can run/walk at the same speed or different speeds, while they workout side-by-side.

### CROSS-REFERENCE TO RELATED APPLICATION

The present application claims priority to, and the benefit of, U.S. Provisional Application No. 63/445,492, which was filed on Feb. 14, 2023, and is incorporated herein by reference in its entirety.

### FIELD OF THE INVENTION

The present invention relates generally to the field of partner treadmill devices. More specifically, the present invention relates to a two-surface treadmill that allows users to exercise with a partner. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in partner treadmill devices. Generally, working out alone can feel isolating and demotivating. Further, sticking to a workout schedule may be difficult when working out alone. Additionally, gym memberships can be costly and crowded, reducing the desire to workout.

In recent years, many people have begun exercising more to improve their health. One popular type of exercise is walking. To make walking more enjoyable, many people walk with a partner. For example, a husband and wife may take a walk together. As another example, a person may take a walk with a dog. However, people who enjoy walking with a partner have problems when they wish to walk at night or when the weather is poor, such as when it is raining, snowing, or just simply cold. In such situations, these people face danger or discomfort or both when they walk outdoors. To avoid these problems, people can choose to walk indoors on a treadmill. However, current treadmills in the art do not provide a satisfactory solution for people who wish to walk with a partner. In particular, a typical treadmill can only accommodate a single treadmill user. Thus, if a person wishes to walk with a partner, two separate treadmills typically would be needed. However, such a solution is expensive. Further, even if cost were not an issue, such a solution might still be unsatisfactory, because separate treadmills can present other problems, such as making it difficult for the two treadmill users to hold hands while walking.

Accordingly, there is a demand for an improved partner treadmill device that provides a treadmill which can simultaneously accommodate two treadmill users side-by-side in a satisfactory manner. More particularly, there is a demand for a partner treadmill device that allows for an enjoyable workout experience with a training partner.

Therefore, there exists a long-felt need in the art for a partner treadmill device that provides users with a two-surface treadmill allowing for the ability to exercise with a partner. There is also a long-felt need in the art for a partner treadmill device that features two separate tread surfaces that can work simultaneously and at the same pace, accommodating both users. Further, there is a long-felt need in the art for a partner treadmill device that eliminates the costs associated with purchasing two separate treadmills. Moreover, there is a long-felt need in the art for a device that allows for an enjoyable workout experience with a training partner, spouse, or anyone wanting to get fit and exercise. Further, there is a long-felt need in the art for a partner treadmill device that improves performance, boosts confidence, and increases time spent exercising. Finally, there is a long-felt need in the art for a partner treadmill device that users can run the same speed or separate speeds on, and which allows partners the opportunity to run side-by-side.

The subject matter disclosed and claimed herein, in one embodiment thereof, comprises a partner treadmill device. The device is a treadmill with two separate running surfaces or treads constructed side-by-side, thereby allowing two users to walk or run at the same time and pace. The partner treadmill device comprises a body component that is configured in the shape of a conventional treadmill, having a base component, two arm components, and a control component. The base component comprises two tread components, constructed side-by-side. Thus, the partner treadmill component can be used by one or two users simultaneously. Further, the control component allows users to operate the tread components and speed of the device. Thus, users can run/walk at the same speed or different speeds, while they workout side-by-side.

In this manner, the partner treadmill device of the present invention accomplishes all of the foregoing objectives and provides users with a device that provides a two-surface treadmill for working out with a partner. The device allows users to work out side-by-side. The device allows users to walk/run at the same speed or different speeds.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a partner treadmill device. The device is a treadmill with two separate running surfaces or treads constructed side-by-side, thereby allowing two users to walk or run at the same time and pace. The partner treadmill device comprises a body component that is configured in the shape of a conventional treadmill but with two tread components that allow one or two users simultaneously. Thus, users can run/walk at the same speed or different speeds, while they workout side-by-side.

In one embodiment, a treadmill device of the present invention can be made in a manner similar to that in which treadmills are presently made, except that, i.e., two belts would be used, instead of one. In view of the disclosure in this specification, it is considered that one of ordinary skill in the art would understand how to make the present invention. In this invention, two treadmill users are positioned side-by-side when they are in a position where, for example, they can hold hands (if the two treadmill users are people) or a human treadmill user can walk beside a dog or other animal.

In one embodiment, the partner treadmill device comprises a body component that is configured in the shape of a conventional treadmill. Further, the body component comprises a base component with two tread components constructed side-by-side. The two tread components comprise two pairs of parallel, spaced rollers rotatably disposed in the base component, and two endless belts, wherein one belt extends around both rollers in one pair of rollers and the other belt extends around both rollers in the other pair of rollers, wherein each belt has a width which is large enough to accommodate one treadmill user, and wherein the two belts are positioned to accommodate two treadmill users side-by-side. Further, each tread component comprises a forward roller, a rear roller, an endless belt having a width suitable to accommodate one treadmill user and a support deck. The support deck is supported by the base component in a generally horizontal position unless inclination is provided, whereby the base component and support deck deviate from the horizontal position. The forward and rear rollers are journaled in the base component for rotation about parallel forward and rear axes. The forward roller is spaced slightly forward of the support deck and the rear roller is spaced slightly rearward of the support deck. The endless belt surrounds the support deck and is entrained around the rollers. An upper reach of the belt extends between the rollers and over the support deck. The upper reach is the surface upon which the users walk or run. The forward roller is rotated by a suitable motor, preferably positioned forward of the forward roller to rotate the belt in a manner to cause the upper reach to move rearwardly.

In one embodiment, one of the pair of spaced rollers is powered by a suitable motor to rotate the roller, thereby moving the belt with the rollers. The belt includes an upper portion which extends between the rollers and which provides a surface upon which a user can walk or run. In one embodiment, the motor(s) used in the present invention must be suitable to rotate the belt(s). For example, the motor(s) could be at least 1.5 horsepower. More preferably, the motor(s) could be 1.75 horsepower, 2.0 horsepower, 2.5 horsepower, 3.0 horsepower, 4.0 horsepower, 5.0 horsepower, or an even higher horsepower. Further, the motor(s) are typically of the continuous duty type.

In one embodiment, the two tread components each comprise a belt that must be wide enough to accommodate one treadmill user, such that two treadmill users can walk/run side-by-side (i.e., such as two adult people side-by-side, or an adult person and a dog/animal side-by-side). For example, each belt could be approximately 15-25 inches wide, depending on the wants and/or needs of a user. Further, each belt can be made of any suitable material known and well-known in the art.

In this embodiment, the belts can have the same width (i.e., if each belt has a width which is large enough to accommodate an adult person) or different widths (i.e., if one belt has a width which is large enough to accommodate an adult person and the other belt has a width which is large enough to accommodate a dog/animal). For example, a belt in this embodiment could have a width of at least 12 inches (i.e., for a small dog), 16 inches, 18 inches, 20 inches, or 24 inches. In a preferred embodiment with two belts, the belts move independently of each other, such that one can be moving at one speed while the other moves at another speed.

In one embodiment, the belt(s) on the tread components can be inclined with an inclination mechanism or mechanisms as is used in the art. In a preferred embodiment with two belts, the belts can be inclined independently and each comprise an inclination mechanism.

In one embodiment, a forward post or posts can extend up from the base component for supporting a control panel component and/or a handlebar. Each of the forward posts has a lower end and an upper end. The lower end is connected to the base component via suitable fasteners and is spaced forward of the forward roller and generally adjacent to the motor. A support plate can be welded or otherwise secured to the upper end of the forward post.

In one embodiment, the control panel component preferably has controls for controlling and monitoring several of the treadmill device's functions. Specifically, the control panel component typically has controls for turning the treadmill device on and off and for varying the speed of the belts on the tread components and sometimes the angle of inclination of the belts relative to the ground. Also, the control panel component has indicators for selectively displaying operational information such as speed, distance traveled, time, degree of inclination, etc. Further, one of the users may press a suitable button on the control panel component to toggle between two or more different displays, which display the operational information. Additionally, the control panel component comprises dual sets of controls for each tread component, allowing a user to set the same speed and/or inclination for both tread components or different speeds and/or inclinations for both tread components. Further, the control panel component can be arranged so that each user can independently control the speed and degree of inclination for that user's belt. Thus, the control panel component can include specific buttons which allow a user to set the first user controls (i.e., speed and/or inclination), a second user controls (i.e., speed and/or inclination), or both user controls (i.e., speed and/or inclination).

In one embodiment, the treadmill device further includes a handlebar having a central upper portion and first (left) and second (right) side portions (i.e., arm components). The upper portion of the handlebar is positioned above the upper surface of the endless belt, toward the front end of the treadmill device, and is attached to the support plate via a suitable threaded fastener. Thus, the upper portion of the handlebar is positioned generally adjacent to the upper end of the forward post. The side portions of the handlebar extend out from the upper portion of the handlebar to create the pair of horizontal arm components. Preferably, the upper portion of the handlebar and at least part of the side portions include a resilient polymeric material as a hand grip. The handlebar optionally includes a middle portion with a hand grip. Each side portion (i.e., arm component) of the handlebar can accommodate a hand of a treadmill user, so that if the two treadmill users are humans positioned side-by-side, the left hand of the person on the left side of the treadmill can grip the left side portion of the handlebar and the right hand of the person on the right side of the treadmill can grip the right side portion of the handlebar, leaving the right hand of the person on the left side of the treadmill free to hold the left hand of the person on the right side of the treadmill, while walking/running. Furthermore, in one embodiment, the side portions (i.e., arm components) each comprise a gripping texture or other non-slip material to prevent a user's hands from slipping when using the treadmill device.

In one embodiment, a middle portion can also be present on the handlebar, wherein the middle portion can extend back from a middle part of the front portion when desired (i.e., when the treadmill users are people who want to have each of their hands on the handlebar rather than holding hands, or when only one treadmill user wishes to use the treadmill and wishes to hold the handlebar with both hands). When the middle portion is not desired (i.e., when the treadmill users wish to hold hands), it can be pivoted so that it hangs down from the front portion, or it can be removed altogether. If a middle portion is not present at all in an embodiment of the present invention and a lone treadmill user wishes to walk or run on a particular part of the treadmill, the left side portion and/or the right side portion could be moved along the front portion and fastened in an appropriate position for use by the single user.

In one embodiment, if one of the treadmill users is an animal such as a dog, a harness could be attached to the treadmill device for use by the dog.

In one embodiment, the partner treadmill device can be collapsed/compacted for storage. For compact storage, the forward post is preferably pivotally connected to the base component for movement of the forward post between an upright position and a stowed position, in which the control panel component is positioned adjacent to the upper reach of the belt. Also, the handlebar is pivotally connected to the base component for movement between an upright position and a stowed position in which the upper portion of the handlebar is positioned forward of the motor. When in their upright positions, the upper portion of the handlebar is secured via suitable fasteners to the support plate, so that the handlebar in part supports and stabilizes both the forward post and the control panel component. The forward post is further locked in its upright position by a suitable threaded fastener, connecting the lower end of the forward post to the base component. With the forward post and the handlebar in their upright positions, the treadmill device is ready for use.

In yet another embodiment, the partner treadmill device comprises a plurality of indicia.

In yet another embodiment, a method of walking or running with a partner simultaneously on a treadmill is disclosed. The method includes the steps of providing a partner treadmill device comprising a body component having a base component with two treads, two arm components, and a control component. The method also comprises stepping onto the first tread component of the device. Further, the method comprises having a partner step onto the second tread component of the device. The method comprises setting a speed for the first and second tread components. Finally, the method comprises walking or running with your partner, side-by-side on the device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the partner treadmill device of the present invention in accordance with the disclosed architecture;

FIG. 2 illustrates a side perspective view of one embodiment of the partner treadmill device of the present invention showing the dual tread components side-by-side in accordance with the disclosed architecture;

FIG. 3 illustrates a front perspective view of one embodiment of the partner treadmill device of the present invention showing the front of the device in accordance with the disclosed architecture;

FIG. 4 illustrates a perspective view of one embodiment of the partner treadmill device of the present invention showing the control component of the device in accordance with the disclosed architecture; and

FIG. 5 illustrates a flowchart showing the method of walking or running with a partner simultaneously on a treadmill in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a partner treadmill device that provides users with a two-surface treadmill allowing for the ability to exercise with a partner. There is also a long-felt need in the art for a partner treadmill device that features two separate tread surfaces that can work simultaneously and at the same pace, accommodating both users. Further, there is a long-felt need in the art for a partner treadmill device that eliminates the costs associated with purchasing two separate treadmills. Moreover, there is a long-felt need in the art for a device that allows for an enjoyable workout experience with a training partner, spouse, or anyone wanting to get fit and exercise. Further, there is a long-felt need in the art for a partner treadmill device that improves performance, boosts confidence, and increases time spent exercising. Finally, there is a long-felt need in the art for a partner treadmill device that users can run the same speed or separate speeds on, and which allows partners the opportunity to run side-by-side.

The present invention, in one exemplary embodiment, is a novel partner treadmill device. The partner treadmill device comprises a body component that is configured in the shape of a conventional treadmill, having a base component, two arm components, and a control component. The base component comprises two tread components, constructed side-by-side. Thus, the partner treadmill component can be used by one or two users simultaneously. Further, the control component allows users to operate the tread components and speed of the device. Thus, users can run/walk at the same speed or different speeds, while they workout side-by-side. The present invention also includes a novel method of walking or running with a partner simultaneously on a treadmill. The method includes the steps of providing a partner treadmill device comprising a body component having a base component with two treads, two arm components, and a control component. The method also comprises stepping onto the first tread component of the device. Further, the method comprises having a partner step onto the second tread component of the device. The method comprises setting a speed for the first and second tread components. Finally, the method comprises walking or running with your partner, side-by-side on the device.

Referring initially to the drawings, FIG. 1 illustrates a perspective view of one embodiment of the partner treadmill device 100 of the present invention. In the present embodiment, the partner treadmill device 100 is an improved partner treadmill device 100 that provides a user 112 with two separate running surfaces or treads 106 constructed side-by-side, thereby allowing two users 112 to walk or run at the same time and pace. Specifically, the partner treadmill device 100 comprises a body component 102 having a base component 104 with two tread components 106, a set of two arm components 108, and a control panel component 110. Thus, users 112 can run/walk at the same speed or different speeds, while they workout side-by-side.

Generally, a treadmill device 100 of the present invention can be made in a manner similar to that in which treadmills are presently made, except that, i.e., two tread components 106 would be used, instead of one. In view of the disclosure in this specification, it is considered that one of ordinary skill in the art would understand how to make the present invention. In this invention, two treadmill users 112 are positioned side-by-side when they are in a position where, for example, they can hold hands (if the two treadmill users 112 are people) or a human treadmill user 112 can walk beside a dog 114 or other animal.

Furthermore, the partner treadmill device 100 comprises a body component 102 that is configured in the shape of a conventional treadmill. Further, the body component 102 comprises a base component 104 with two tread components 106 constructed side-by-side. The two tread components 106 comprise two pairs of parallel, spaced rollers 116, 118 rotatably disposed in the base component 104, and two endless belts 120, wherein one belt 120 extends around both rollers 116, 118 in one pair of rollers and the other belt 120 extends around both rollers 116, 118 in the other pair of rollers, wherein each belt 120 has a width which is large enough to accommodate one treadmill user 112, and wherein the two belts 120 are positioned to accommodate two treadmill users 112 side-by-side.

Further, each tread component 106 comprises a forward roller 116, a rear roller 118, an endless belt 120 having a width suitable to accommodate one treadmill user 112, and a support deck 122. The support deck 122 is supported by the base component 104 in a generally horizontal position, unless inclination is provided, whereby the base component 104 and support deck 122 deviate from the horizontal position. The forward 116 and rear 118 rollers are journalled in the base component 104 for rotation about parallel forward and rear axes. The forward roller 116 is spaced slightly forward of the support deck 122 and the rear roller 118 is spaced slightly rearward of the support deck 122. The endless belt 120 surrounds the support deck 122 and is entrained around the rollers 116, 118.

Additionally, an upper reach 124 of the belt 120 extends between the rollers 116, 118 and over the support deck 122. The upper reach 124 is the surface upon which the users 112 walk or run. The forward roller 116 is rotated by a suitable motor 126, preferably positioned forward of the forward roller 116 to rotate the belt 120 in a manner to cause the upper reach 124 to move rearwardly.

Furthermore, the two tread components 106 each comprise a belt 120 that must be wide enough to accommodate one treadmill user 112, such that two treadmill users 112 can walk/run side-by-side (i.e., such as two adult people side-by-side, or an adult person and a dog/animal 114 side-by-side). For example, each belt 120 could be approximately 15-25 inches wide, depending on the wants and/or needs of a user 112. Further, each belt 120 can be made of any suitable material well-known in the art.

Generally, the belts 120 can have the same width (i.e., if each belt has a width which is large enough to accommodate an adult person) or different widths (i.e., if one belt has a width which is large enough to accommodate an adult person and the other belt has a width which is large enough to accommodate a dog/animal). For example, a belt 120 in this embodiment could have a width of at least 12 inches (i.e., for a small dog), 16 inches, 18 inches, 20 inches, or 24 inches. In a preferred embodiment with two belts 120, the belts 120 move independently of each other, such that one can be moving at one speed while the other moves at another speed.

Further, the belt(s) 120 on the tread components 106 can be inclined with an inclination mechanism 128 or mechanisms as is used in the art. In a preferred embodiment with two belts 120, the belts 120 can be inclined independently and each comprise an inclination mechanism 128.

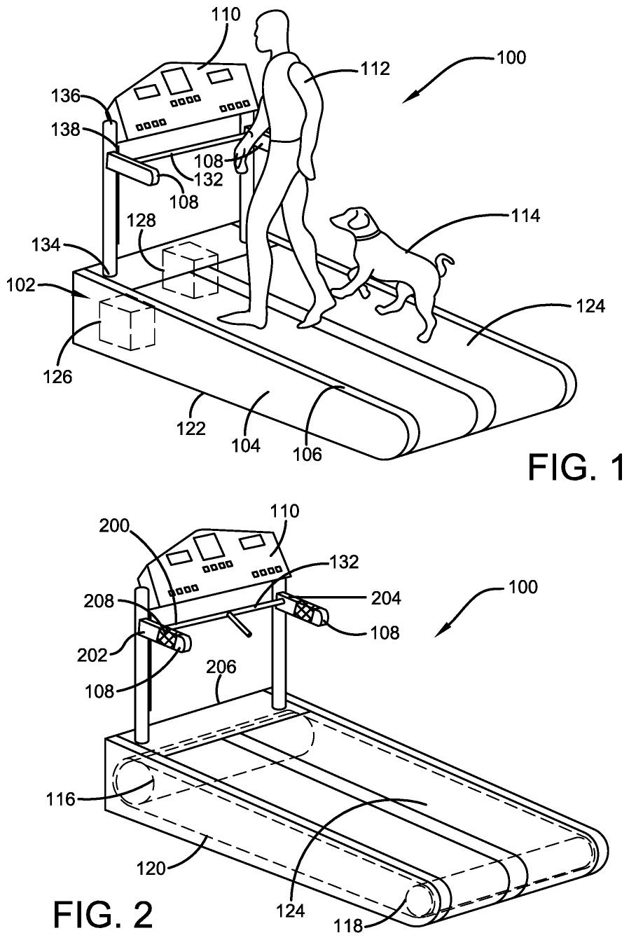

As shown in FIG. 2, one of the pair of spaced rollers 116, 118 is powered by a suitable motor 126 to rotate the roller 116, 118, thereby moving the belt 120 with the rollers 116, 118. The belt 120 includes an upper portion (i.e., upper reach 124) which extends between the rollers 116, 118 and which provides a surface upon which a user 112 can walk or run. In one embodiment, the motor(s) 126 used in the present invention must be suitable to rotate the belt(s) 120. For example, the motor(s) 126 could be at least 1.5 horsepower. More preferably, the motor(s) 126 could be 1.75 horsepower, 2.0 horsepower, 2.5 horsepower, 3.0 horsepower, 4.0 horsepower, 5.0 horsepower, or an even higher horsepower. Further, the motor(s) 126 are typically of the continuous duty type.

Further, in one embodiment, a forward post or posts 130 can extend up from the base component 104 for supporting a control panel component 110 and/or a handlebar 132. Each of the forward posts 130 has a lower end 134 and an upper end 136. The lower end 134 is connected to the base component 104 via any suitable fasteners and is spaced forward of the forward roller 116 and generally adjacent to the motor 126. A support plate 138 can be welded or otherwise secured to the upper end 136 of the forward post 130.

Additionally, in one embodiment, the treadmill device 100 further includes a handlebar 132 having a central upper portion 200 and first (left) 202 and second (right) 204 side portions (i.e., arm components 108). The upper portion 200 of the handlebar 132 is positioned above the upper surface of the endless belt 120, toward the front end 206 of the treadmill device 100, and is attached to the support plate 138 via a suitable threaded fastener. Thus, the upper portion 200 of the handlebar 132 is positioned generally adjacent to the upper end 136 of the forward post 130. The side portions 202, 204 of the handlebar 132 extend out from the upper portion 200 of the handlebar 132 to create the pair of horizontal arm components 108. Preferably, the upper portion 200 of the handlebar 132 and at least part of the side portions 202, 204 include a resilient polymeric material as a hand grip 208.

The handlebar 132 optionally includes a middle portion 210 with a hand grip 208. Each side portion 202, 204 (i.e., arm component 108) of the handlebar 132 can accommodate a hand of a treadmill user 112, so that if the two treadmill users 112 are humans positioned side-by-side, the left hand of the person on the left side of the treadmill can grip the left side portion 202 of the handlebar 132 and the right hand of the person on the right side of the treadmill can grip the right side portion 204 of the handlebar 132, leaving the right hand of the person on the left side of the treadmill free to hold the left hand of the person on the right side of the treadmill, while walking/running. Furthermore, in one embodiment, the side portions 202, 204 (i.e., arm components 108) each comprise a gripping texture 208 or other non-slip material to prevent a user's hands from slipping when using the treadmill device 100.

In one embodiment, a middle portion 210 can also be present on the handlebar 132, wherein the middle portion 210 can extend back from a middle part of the upper portion 200 when desired (i.e., when the treadmill users 112 are people who want to have each of their hands on the handlebar 132 rather than holding hands, or when only one treadmill user 112 wishes to use the treadmill device 100 and wishes to hold the handlebar 132 with both hands). When the middle portion 210 is not desired (i.e., when the treadmill users 112 wish to hold hands), it can be pivoted so that it hangs down from the upper portion 200, or it can be removed altogether. If a middle portion 210 is not present at all in an embodiment of the present invention and a lone treadmill user 112 wishes to walk or run on a particular part of the treadmill device 100, the left side portion 202 and/or the right side portion 204 could be moved along the upper portion 200 and fastened in an appropriate position for use by the single user 112.

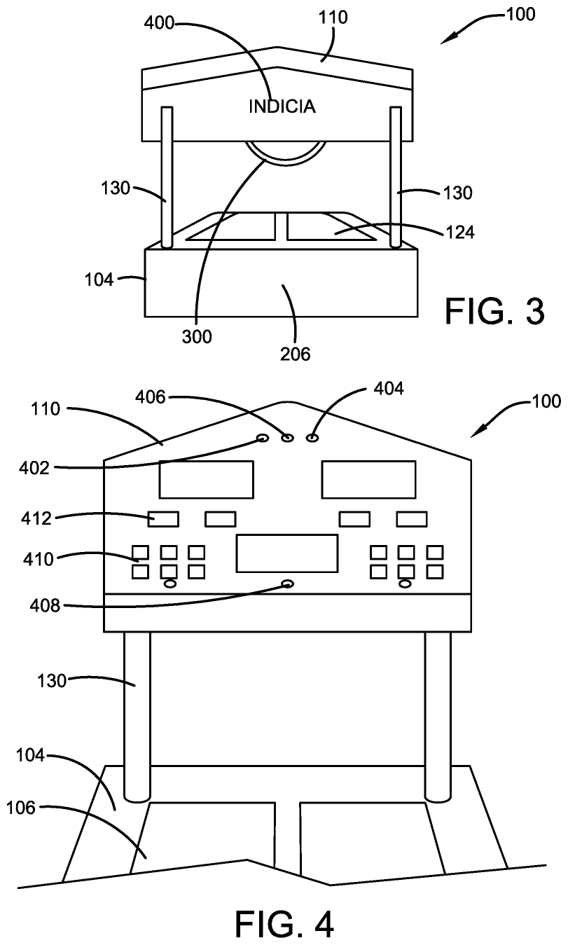

As shown in FIG. 3, if one of the treadmill users is an animal such as a dog 114, a harness 300 could be attached to the treadmill device 100 for use by the dog 114.

Further, in one embodiment, the partner treadmill device 100 can be collapsed/compacted for storage. For compact storage, the forward post 130 is preferably pivotally connected to the base component 104 for movement of the forward post 130 between an upright position and a stowed position, in which the control panel component 110 is positioned adjacent to the upper reach 124 of the belt 120. Also, the handlebar 132 is pivotally connected to the base component 104 for movement between an upright position and a stowed position in which the upper portion 200 of the handlebar 132 is positioned forward of the motor 126. When in their upright positions, the upper portion of 200 the handlebar 132 is secured via suitable fasteners to the support plate 138, so that the handlebar 132 in part supports and stabilizes both the forward post 130 and the control panel component 110. The forward post 130 is further locked in its upright position by a suitable threaded fastener, connecting the lower end 134 of the forward post 130 to the base component 104. With the forward post 130 and the handlebar 132 in their upright positions, the treadmill device 100 is ready for use.

As shown in FIG. 4, the control panel component 110 preferably has controls for controlling and monitoring several of the treadmill device's functions. Specifically, the control panel component 110 typically has controls for turning the treadmill device 100 on and off (i.e., power button 408) and for varying the speed 410 of the belts 120 on the tread components 106 and sometimes the angle of inclination 412 of the belts 120 relative to the ground. Also, the control panel component 110 has indicators for selectively displaying operational information such as speed 410, distance traveled, time, degree of inclination 412, power 408, etc. Further, one of the users 112 may press a suitable button on the control panel component 110 to toggle between two or more different displays, which display the operational information. Additionally, the control panel component 110 comprises dual sets of controls for each tread component 106, allowing a user 112 to set the same speed and/or inclination for both tread components 106 or different speeds and/or inclinations for both tread components 106. Further, the control panel component 110 can be arranged so that each user 112 can independently control the speed and degree of inclination for that user's belt 120. Thus, the control panel component 110 can include specific buttons which allow a user 112 to set the first user controls 402 (i.e., speed and/or inclination), a second user controls 404 (i.e., speed and/or inclination), or both user controls 406 (i.e., speed and/or inclination).

In yet another embodiment, the partner treadmill device 100 comprises a plurality of indicia 400. The body component 102 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as, but not limited to, patterns, logos, emblems, images, symbols, designs, letters, words, characters, animals, advertisements, brands, etc., that may or may not be a treadmill, partner, or brand related.

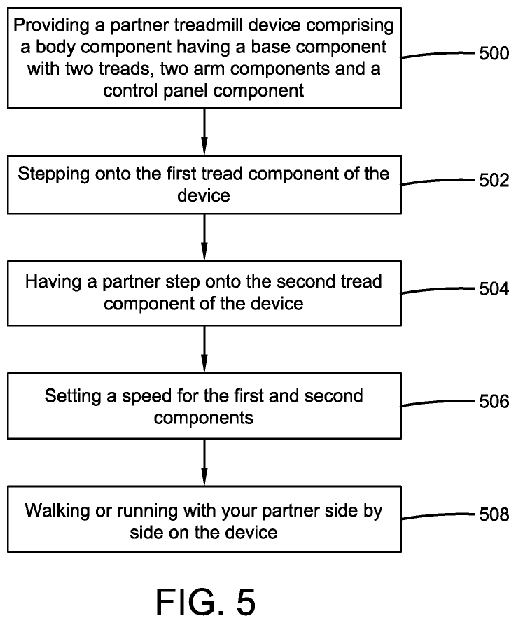

FIG. 5 illustrates a flowchart of the method of walking or running with a partner simultaneously on a treadmill. The method includes the steps of at 500, providing a partner treadmill device comprising a body component having a base component with two treads, two arm components, and a control component. The method also comprises at 502, stepping onto the first tread component of the device. Further, the method comprises at 504, having a partner step onto the second tread component of the device. The method comprises at 506, setting a speed for the first and second tread components. Finally, the method comprises at 508, walking or running with your partner, side-by-side on the device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “partner treadmill device”, “treadmill device”, “partner device”, and “device” are interchangeable and refer to the partner treadmill device 100 of the present invention.

Notwithstanding the foregoing, the partner treadmill device 100 of the present invention can be of any suitable size and configuration as is known in the art without affecting the overall concept of the invention, provided that it accomplishes the above-stated objectives. One of ordinary skill in the art will appreciate that the partner treadmill device 100 as shown in FIGS. 1-5 is for illustrative purposes only, and that many other sizes and shapes of the partner treadmill device 100 are well within the scope of the present disclosure. Although the dimensions of the partner treadmill device 100 are important design parameters for user convenience, the partner treadmill device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A partner treadmill device that provides a user with two separate running surfaces for two users to walk or run at the same time, the partner treadmill device comprising:
a body component with a base component;
a set of two arm components; and
a control panel component;
wherein the base component comprises two tread components configured side-by-side; and
further wherein users can utilize the two tread components simultaneously to workout.

2. The partner treadmill device of claim 1, wherein each of the two tread components comprise a support deck with a forward roller and a rear roller spaced apart, and one belt extends around both the forward roller and the rear roller.

3. The partner treadmill device of claim 2, wherein each belt has a width which is large enough to accommodate one treadmill user, and further wherein the two belts are positioned to accommodate two treadmill users side-by-side.

4. The partner treadmill device of claim 3, wherein the forward roller and the rear roller are journalled in the base component for rotation about parallel forward and rear axes, and the belt surrounds the support deck and is entrained around the forward roller and the rear roller.

5. The partner treadmill device of claim 4, wherein an upper reach of the belt extends between the forward roller and the rear roller and over the support deck, the upper reach is surface upon which users walk or run.

6. The partner treadmill device of claim 5, wherein the forward roller is rotated by a suitable motor, preferably positioned forward of the forward roller to rotate the belt in a manner to cause the upper reach to move rearwardly.

7. The partner treadmill device of claim 6, wherein the two belts have different widths.

8. The partner treadmill device of claim 6, wherein the two belts have same width.

9. The partner treadmill device of claim 6, wherein the two belts move independently of each other.

10. The partner treadmill device of claim 9, wherein at least one forward post extends up from the base component for supporting a control panel component and a handlebar.

11. The partner treadmill device of claim 10, wherein the handlebar has a central upper portion and a left and a right side portions that each extend out horizontally toward a user to form arm components.

12. The partner treadmill device of claim 11, wherein the control panel component has controls for power, and for varying speed of the two belts, and for varying angle of inclination of the two belts, and has dual sets of controls for each tread component, allowing a user to independently control the speed each tread component.

13. A partner treadmill device that provides a user with two separate running surfaces for two users to walk or run at the same time, the partner treadmill device comprising:
a body component with a base component that comprises two tread components;
a set of two arm components; and
a control panel component that comprises dual sets of controls for each tread component, allowing a user to independently control the speed each tread component; and
wherein each of the two tread components comprise a support deck with a forward roller and a rear roller spaced apart, and one belt extends around both the forward roller and the rear roller;
wherein each belt has a width which is large enough to accommodate one treadmill user,
and wherein the two belts are positioned to accommodate two treadmill users side-by-side;
wherein the forward roller and the rear roller are journaled in the base component for rotation about parallel forward and rear axes, and the belt surrounds the support deck and is entrained around the forward roller and the rear roller;
wherein an upper reach of the belt extends between the forward roller and the rear roller and over the support deck, the upper reach is surface upon which users walk or run;
wherein the forward roller is rotated by a suitable motor, preferably positioned forward of the forward roller to rotate the belt in a manner to cause the upper reach to move rearwardly;
wherein the two belts move independently of each other;
wherein users can utilize the two tread components simultaneously to workout;
wherein at least one forward post extends up from the base component for supporting a control panel component and a handlebar; and
further wherein the handlebar has a central upper portion and a left and a right side portions that each extend out horizontally toward a user to form the set of two arm components.

14. The partner treadmill device of claim 13, wherein the handlebar has a middle portion that can extend between the two belts when needed, and can be pivoted so that it hangs down or can be removed when not needed.

15. The partner treadmill device of claim 13, wherein an animal, such as a dog can utilize a harness attached to the partner treadmill device to run on a tread component with a user on a second tread component.

16. The partner treadmill device of claim 13, wherein the partner treadmill device can be collapsed/compacted for storage, by pivoting the at least one forward post and the control panel component to the base component.

17. The partner treadmill device of claim 13 further comprising a plurality of indicia.

18. The partner treadmill device of claim 13, wherein the two belts have different widths.

19. The partner treadmill device of claim 13, wherein the two belts have same width.

20. A method of walking or running with a partner simultaneously on a treadmill, the method comprising the following steps:
providing a partner treadmill device comprising a body component having a base component with two treads, two arm components, and a control component;
stepping onto the first tread component of the device;
having a partner step onto the second tread component of the device;
setting a speed for the first and second tread components; and
walking or running with your partner, side-by-side on the device.
